(19) United States
(12) Patent Application Publication
(10) Pub. No.: US 2018/0375123 A1
(43) Pub. Date: Dec. 27, 2018

(54) GAS-LIQUID SEPARATOR

(71) Applicant: HONDA MOTOR CO., LTD., Tokyo (JP)

(72) Inventors: Yuji Okamura, Wako-shi (JP); Tetsuya Fukuda, Wako-shi (JP); Yoichiro Saito, Mito-shi (JP)

(21) Appl. No.: 16/012,844

(22) Filed: Jun. 20, 2018

(30) Foreign Application Priority Data
Jun. 22, 2017 (JP) 2017-122304

(51) Int. Cl. H01M 8/04119; B01D 45/08

(52) U.S. Cl. CPC H01M 8/04164; H01M 2250/20; B01D 45/08

(57) ABSTRACT

A gas-liquid separator includes a casing in which a first inlet port, a second inlet port, and an outlet port are formed. Inside the casing, a first gas-liquid separation chamber and a second gas-liquid separation chamber are formed by a partition wall. A gas-liquid two-phase flow that flows in from the first inlet port passes through the first gas-liquid separation chamber and is subjected to gas-liquid separation. On the other hand, a gas-liquid two-phase flow that flows in from the second inlet port passes through the second gas-liquid separation chamber and is subjected to gas-liquid separation. The gas flows after having undergone gas-liquid separation are collected together in a collection chamber, and are further discharged from the outlet port.

### CROSS-REFERENCE TO RELATED APPLICATION

This application is based upon and claims the benefit of priority from Japanese Patent Application No. 2017-122304 filed on Jun. 22, 2017, the contents of which are incorporated herein by reference.

### BACKGROUND OF THE INVENTION

### Field of the Invention

The present invention relates to a gas-liquid separator, and more particularly, to a gas-liquid separator suitable for attachment to a fuel cell.

### Description of the Related Art

As is well known, a fuel cell includes an anode and a cathode which face toward one another with an electrolyte (for example, a solid polymer membrane) being sandwiched therebetween. A fuel gas such as hydrogen is supplied to the anode, and an oxygen containing gas such as compressed air is supplied to the cathode to thereby generate electricity. At least portions of the fuel gas and the oxygen containing gas are consumed. However, unreacted components thereof are discharged as fuel exhaust gas and oxygen containing exhaust gas from the anode and the cathode to a fuel exhaust gas discharge flow passage and an oxygen containing exhaust gas discharge flow passage, respectively. In this manner, the fuel cell system is constituted by adding reaction gas supply equipment and discharge equipment, etc., with respect to the fuel cell. The fuel exhaust gas is a gas-liquid two-phase flow containing water. Thus, a gas-liquid separator for separating the fuel exhaust gas into hydrogen and water is provided in the fuel exhaust gas discharge flow passage. Hydrogen from which the water is separated is resupplied to the anode. On the other hand, the water is discharged via a drain valve from the gas-liquid separator.

As a gas-liquid separator which performs such a function, as described in Japanese Laid-Open Patent Publication No. 07-259549 (refer in particular to paragraphs [0021], [0055] and FIGS. 2 and 10), a gas liquid separator is known in which a plurality of inlet ports are formed in a casing. In such a gas-liquid separator, a gas-liquid two-phase flow (in the case of Japanese Laid-Open Patent Publication No. 07-259549, an exhaust gas from an engine containing drain water) is supplied separately into the casing from each of the respective inlet ports, and after being combined into a mixed flow, gas-liquid separation is carried out thereon. The exhaust gas from which the drain water has been separated is discharged from a single outlet port.

### SUMMARY OF THE INVENTION

In the case that a gas-liquid two-phase flow is supplied separately into a casing from a plurality of inlet ports, situations may occur in which the gas-liquid two-phase flow is not sufficiently separated into a liquid phase and a gas phase (gas flow). Stated otherwise, in a gas-liquid separator having such a configuration, an inconvenience is manifested in that the gas-liquid separation efficiency is insufficient.

A principal object of the present invention is to provide a gas-liquid separator having a casing in which a plurality of inlet ports are formed therein for supplying a gas-liquid two-phase flow.

Another object of the present invention is to provide a gas-liquid separator in which a sufficient gas-liquid separation efficiency is exhibited.

According to an embodiment of the present invention, a gas-liquid separator is provided, which is configured to separate a gas-liquid two-phase flow into a gas phase and a liquid phase inside a casing, wherein the casing comprises:

a first inlet port and a second inlet port to which the gas-liquid two-phase flow is separately supplied;

a first gas-liquid separation chamber configured to separate the gas-liquid two-phase flow introduced from the first inlet port into a liquid phase and a first gas flow;

a second gas-liquid separation chamber separated from the first gas-liquid separation chamber by a partition wall, and configured to separate the gas-liquid two-phase flow introduced from the second inlet port into a liquid phase and a second gas flow;

a collection chamber configured to collect the first gas flow obtained in the first gas-liquid separation chamber and the second gas flow obtained in the second gas-liquid separation chamber, and thereby produce a merged flow; and

an outlet port through which the merged flow is discharged.

An intensive study undertaken by the inventors of the present invention has revealed that the reason why the gas-liquid separation efficiency becomes insufficient in a gas-liquid separator in which gas-liquid two-phase flows are supplied separately into the casing from a plurality of inlet ports is due to the fact that the fluxes of the gas-liquid two-phase flows supplied from the respective inlet ports interfere with each other, thus making it difficult to adequately lower the flow rates of the gas-liquid two-phase flows. Interference between the fluxes becomes particularly conspicuous when the fluid pressures and the flow rates, etc., of the gas-liquid two-phase flows differ from each other.

Thus, according to the present invention, as described above, the gas-liquid two-phase flows which flow in from the respective inlet ports are supplied into separate gas-liquid separation chambers, and gas-liquid separation is carried out respectively in each of the gas-liquid separation chambers. Therefore, it is possible to avoid a situation in which the fluxes interfere with each other.

The first inlet port and the second inlet port may be disposed in a manner so that the heights thereof differ from each other. More specifically, for example, the first inlet port may be disposed higher (at a higher position) than the second inlet port. In the case of a gas-liquid separator having only a single gas-liquid separation chamber, interference between the fluxes becomes conspicuous. However, according to the present invention in which the above-described configuration is adopted, even in such a case, it is possible to sufficiently separate the gas-liquid two-phase flows, which flow in from each of the inlet ports, into a liquid phase and a gas phase. Further, in this case, the gas-liquid two-phase flow introduced from the first inlet port may be guided downward, and thereafter raised and directed toward the collection chamber.

On the other hand, the gas-liquid two-phase flow introduced from the downward (lower positioned) second inlet port may be raised, and thereafter, made to descend and be directed toward the collection chamber.

A breathing hole may be preferably formed in the partition wall and configured to enable the first gas-liquid separation chamber and the second gas-liquid separation chamber to communicate with each other. By such a breathing hole, it is possible to balance the fluid pressures and the flow rates of the gas-liquid two-phase flows in the first gas-liquid separation chamber and the second gas-liquid separation chamber. Accordingly, a special design, for example, providing one of the gas-liquid separation chambers with a pressure resistant structure or the like, is rendered unnecessary.

Further, for example, when a large amount of the liquid phase is separated in the first gas-liquid separation chamber, then if the liquid surface level is of a height exceeding that of the breathing hole, the liquid phase passes through the breathing hole and moves into the second gas-liquid separation chamber. Therefore, the liquid surface levels in the first gas-liquid separation chamber and the second gas-liquid separation chamber can be placed at substantially the same height. Consequently, storage of an excessive amount of the liquid phase in the first gas-liquid separation chamber (or the second gas-liquid separation chamber), and due to such an occurrence, difficulty in carrying out gas-liquid separation in the first gas-liquid separation chamber (or the second gas-liquid separation chamber) can be avoided.

Accordingly, there is no need to increase the volumes of the first gas-liquid separation chamber and the second gas-liquid separation chamber in order to enable a large amount of the liquid phase to be stored therein. Therefore, it is possible to reduce the size of the gas-liquid separator, together with enabling a narrowing of the installation space for the gas-liquid separator, or in other words, achieving space conservation.

In the case that the gas-liquid separator includes a reservoir configured to communicate with both the first gas-liquid separation chamber and the second gas-liquid separation chamber, and to store the liquid phase separated from the gas-liquid two-phase flow in the first gas-liquid separation chamber and the second gas-liquid separation chamber, the breathing hole may preferably be formed at a position above a liquid surface level of the liquid phase, which has moved from the reservoir into the first gas-liquid separation chamber and the second gas-liquid separation chamber when the gas-liquid separator is placed in an inclined posture. More specifically, the position of the breathing hole preferably is higher than the liquid surface level when the entire amount of the liquid phase stored in the reservoir has been moved into the first gas-liquid separation chamber and the second gas-liquid separation chamber.

Consequently, even if the gas-liquid separator is placed in an inclined condition, the state in which the first gas-liquid separation chamber and the second gas-liquid separation chamber communicate with each other is maintained through the breathing hole. Therefore, it is possible to balance the fluid pressures and the flow rates of the gas-liquid two-phase flows in the first gas-liquid separation chamber and the second gas-liquid separation chamber, and for the liquid surface position of the liquid phases in both of the gas-liquid separation chambers to be made substantially equal.

The gas flow which has flowed into the collection chamber still contains a small amount of liquid therein. The liquid portion adheres as a liquid phase (typically, in the form of droplets) on the inner wall of the collection chamber. Therefore, a guide path configured to guide the liquid phase to a liquid discharge portion may preferably be provided in the casing. In accordance with this feature, the liquid phase inside the collection chamber can be prevented from being discharged together with the gas flow from the outlet port.

The first inlet port, the second inlet port, and the outlet port may be preferably provided on the same end surface of the casing. This is because, in this case, the process of forming the first inlet port, the second inlet port, and the outlet port for obtaining the casing becomes easy to perform. Moreover, in this case, the second inlet port may be opened at the surface of the partition wall in the second gas-liquid separation chamber.

Further, a first guide member and a second guide member may preferably be provided in the first gas-liquid separation chamber and the second gas-liquid separation chamber, respectively, to guide the first gas flow and the second gas flow in a manner so that the flow directions thereof change. With such a configuration, due to the presence of the first guide member and the second guide member, while being guided by the guide members, the gas-liquid two-phase flows remain within the gas-liquid separation chambers for a comparatively long time period. Therefore, the gas-liquid two-phase flows are sufficiently separated into the liquid phase and the gas phase (gas flow), whereby an adequate gas-liquid separation efficiency can be obtained.

The gas-liquid separator, which is configured as described above, can be adopted, for example, as a constituent device of a fuel cell system including a fuel cell. In this case, the fuel exhaust gas discharged from the anode of the fuel cell is supplied as the gas-liquid two-phase flow to the gas-liquid separator.

In the present invention, the gas-liquid two-phase flows which flow in from the plurality of inlet ports are supplied into separate gas-liquid separation chambers, and gas-liquid separation is carried out respectively in each of the gas-liquid separation chambers. Therefore, it is possible to avoid a situation in which the fluxes of the gas-liquid two-phase flows flowing in from the separate inlet ports interfere with each other.

Therefore, the gas-liquid two-phase flow is sufficiently separated into a liquid phase and a gas phase (gas flow) in each of the gas-liquid separation chambers. Stated otherwise, a gas-liquid separator can be obtained in which a sufficient gas-liquid separation efficiency is exhibited.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of principal components of a fuel cell system including a gas-liquid separator according to an embodiment of the present invention;

FIG. 2 is a schematic perspective view of principal components of the gas-liquid separator according to the embodiment of the present invention;

FIG. 3 is a schematic side view with partial omission showing principal components of the gas-liquid separator of FIG. 2;

FIG. 4 is a schematic side view of principal components of the gas-liquid separator of FIG. 2; and

FIG. 5 is a schematic side view of principal components at a time that the gas-liquid separator of FIG. 2 is placed in an inclined posture.

### DESCRIPTION OF THE PREFERRED EMBODIMENTS

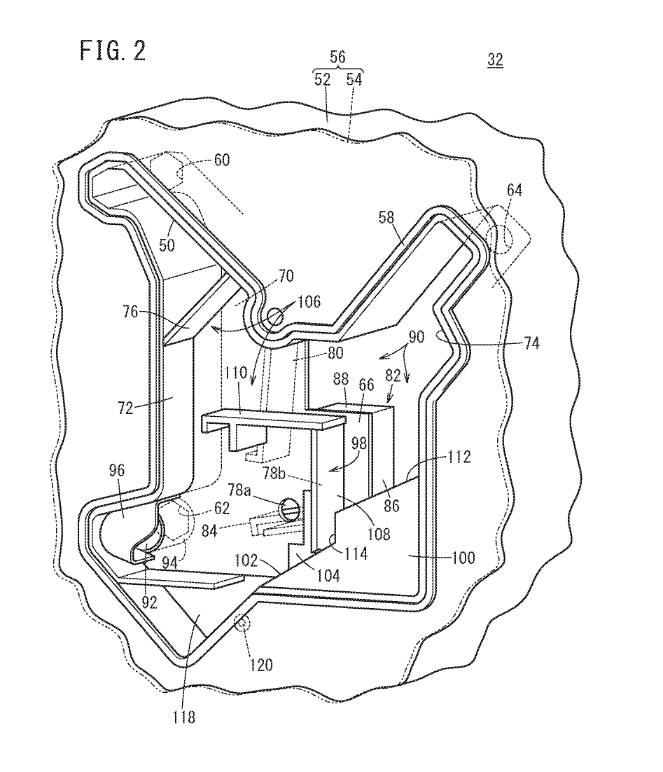

A preferred embodiment of a gas-liquid separator according to the present invention will be described in detail below with reference to the accompanying drawings. In the present embodiment, a case is exemplified in which the gas-liquid separator is attached to a fuel cell to thereby constitute a fuel cell system. Further, in the following description, up, down, left, and right orientations of the gas-liquid separator correspond to the up, down, left, and right directions shown in FIGS. 2 to 4, but this is simply for the sake of convenience and to facilitate understanding. In particular, the illustrated left and right directions do not necessarily specify the left and right directions when the gas-liquid separator is actually used.

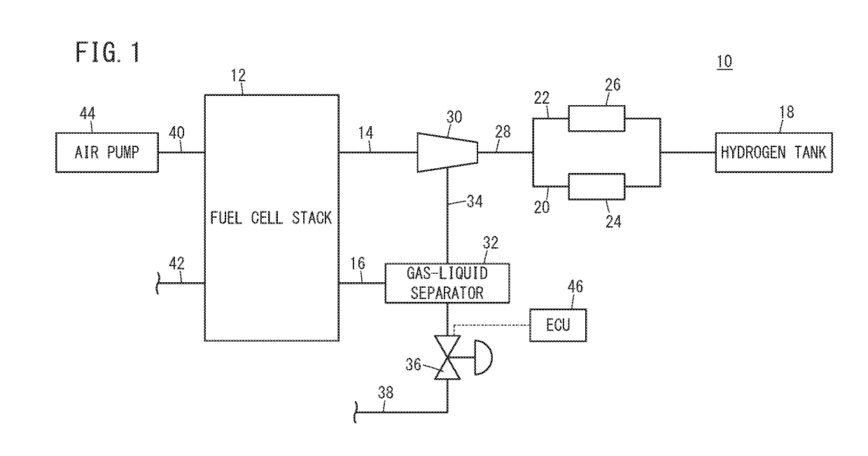

Initially, the fuel cell system will be described briefly with reference to FIG. 1. A fuel cell system 10 is an in-vehicle type of fuel cell system which is installed in a fuel cell vehicle (not shown) such as a fuel cell electric vehicle or the like.

The fuel cell system 10 includes a fuel cell stack 12 which is constituted by stacking a plurality of non-illustrated fuel cells. Each of the individual fuels cells is configured, for example, by sandwiching between a pair of separators an electrolyte electrode assembly (e.g., membrane electrode assembly) having an electrolyte made up from a solid polymer membrane, and an anode and a cathode, which face toward each other with the electrolyte interposed therebetween. It should be noted that such a configuration is well known, and therefore, illustration and a detailed description thereof are omitted.

The fuel cell system 10 further includes a hydrogen supply flow passage 14 (fuel gas supply flow passage) attached to the fuel cell stack 12 for supplying a fuel gas to the anode, and a hydrogen discharge flow passage 16 (fuel exhaust gas discharge flow passage) for discharging the fuel exhaust gas from the anode. Among these passages, a hydrogen tank 18 in which high-pressure hydrogen is stored as the fuel gas is connected to the hydrogen supply flow passage 14.

The hydrogen supply flow passage 14 branches into two branch paths, and therefore, the hydrogen supply flow passage 14 includes a first branch path 20 and a second branch path 22. A first injector 24 and a second injector 26 are disposed respectively in the first branch path 20 and the second branch path 22. The first branch path 20 and the second branch path 22 merge together on a downstream side of the first injector 24 and the second injector 26 to thereby form a merged passage 28, and an ejector 30 is disposed in the merged passage 28.

A gas-liquid separator 32 is connected to the other hydrogen discharge flow passage 16. A circulation flow passage 34 that departs from the gas-liquid separator 32 is connected to the ejector 30. Further, a drainage flow passage 38, through which the water is discharged via a drain valve 36, is provided at the bottom of the gas-liquid separator 32.

The fuel cell system 10 further includes an air supply flow passage 40 (oxygen containing gas supply flow passage) for supplying compressed air as an oxygen containing gas to the cathode, and an air discharge flow passage 42 (oxygen containing gas discharge flow passage) for discharging exhaust compressed air from the cathode. An air pump 44 (compressor) for compressing and supplying air is provided in the air supply flow passage 40.

A non-illustrated coolant supply flow passage through which a coolant is supplied to the fuel cell stack 12 is further provided in the fuel cell stack 12, and an ECU 46 serving as a control unit is attached thereto for controlling the fuel cell stack 12 as a whole. The fuel cell system 10 is constructed in the manner described above.

Next, the gas-liquid separator 32 according to the present embodiment will be described.

FIGS. 2 to 4 are a perspective view of principal components, a schematic side view with partial omission showing principal components, and a schematic side view of principal components, respectively, of the gas-liquid separator 32 according to the present embodiment. The gas-liquid separator 32 comprises a casing 56 having a main body member 52 in which there is formed an internal chamber 50 that opens on one end surface, and a closing member 54 attached to the one end surface to thereby close the internal chamber 50. A space formed between the main body member 52 and the closing member 54 is sealed by a sealing material 58.

A first inlet port 60 and a second inlet port 62 which communicate with the internal chamber 50 are formed respectively at upper left and lower left portions on another end surface of the main body member 52. More specifically, the first inlet port 60 is disposed higher (at a higher position) than the second inlet port 62. Further, an outlet port 64 is formed at an upper right portion. Accordingly, the gas-liquid separator 32 has a plurality of (in this case, two) inlet ports 60, 62, and a single outlet port 64.

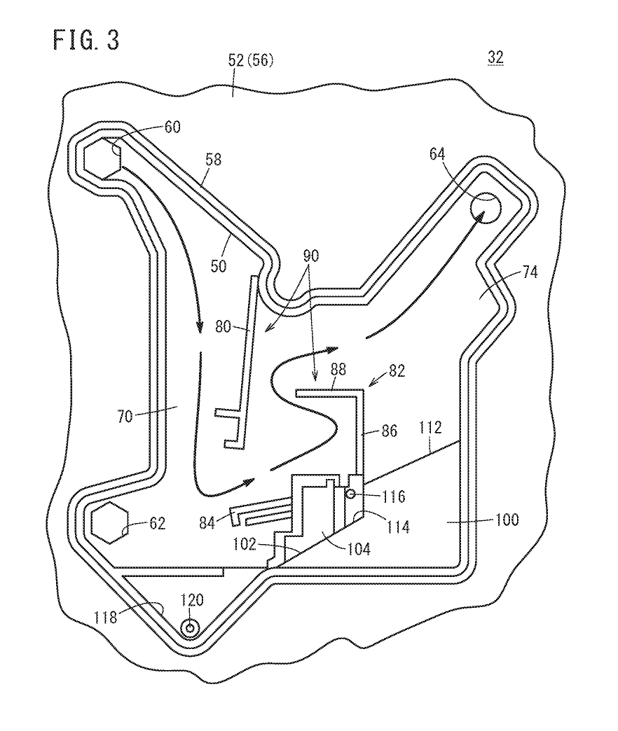

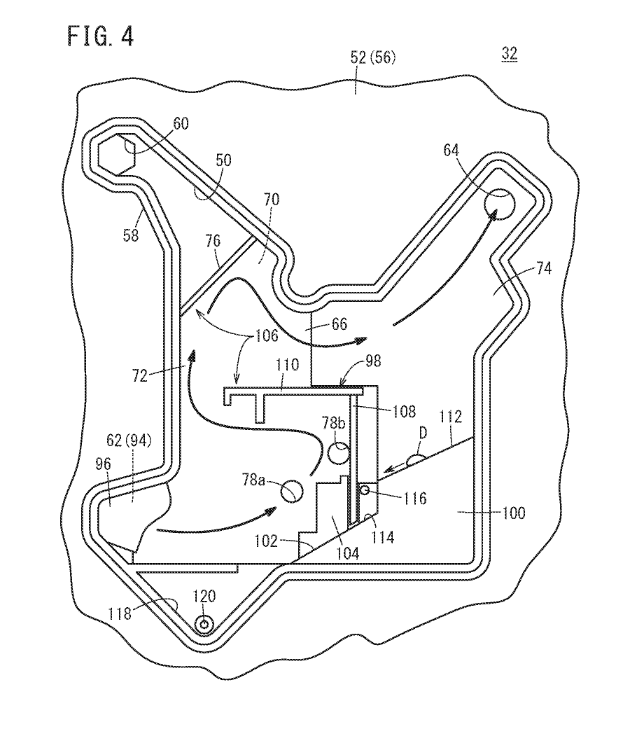

A partition wall 66 which is made from a plate material is attached to and extends in the internal chamber 50. The interior of the internal chamber 50 is divided by the partition wall 66 into a first gas-liquid separation chamber 70 on the rear side of the drawing sheet, and a second gas-liquid separation chamber 72 on the front side of the drawing sheet in FIG. 2. In FIG. 3, in which the closing member 54, the partition wall 66, and a second guide member 106 (to be described later) are omitted from illustration, the first gas-liquid separation chamber 70 is shown, and in FIG. 4, in which the partition wall 66 is illustrated, the second gas-liquid separation chamber 72 is shown.

Moreover, the area of the partition wall 66 is substantially one half the area of the internal chamber 50, which is determined in a planar view of the internal chamber 50 (see FIG. 4). More specifically, in the internal chamber 50, the partition wall 66 exists only on an upstream side in the flow direction of the discharged hydrogen. A space in the internal chamber 50 in which the partition wall 66 does not exist is located more on the downstream side in the flow direction than the first gas-liquid separation chamber 70 and the second gas-liquid separation chamber 72, and the space serves as a collection chamber 74 in which the discharged hydrogen having passed through the first gas-liquid separation chamber 70, and the discharged hydrogen having passed through the second gas-liquid separation chamber 72 merge (are collected) together and become a merged flow.

A dam plate 76 is provided on an upper left side of the end surface on the front side of the partition wall 66. The dam plate 76 serves to prevent the discharged hydrogen, which is introduced into the casing 56 from the first inlet port 60, from flowing into the second gas-liquid separation chamber 72, and together therewith, carries out a role of changing the flow direction of the discharged hydrogen.

Further, two breathing holes 78a, 78b are formed in the partition wall 66. The first gas-liquid separation chamber 70 and the second gas-liquid separation chamber 72 communicate with each other through the breathing holes 78a, 78b.

As shown in FIGS. 2 and 3, on the other end surface of the main body member 52 on which the first inlet port 60, the second inlet port 62, and the outlet port 64 are formed, a first regulating member 80 and a second regulating member 82 are provided in a manner so as to project into the internal chamber 50. The first regulating member 80 extends toward the lower left in a slightly inclined manner with respect to the vertical direction. On the other hand, the second regulating member 82 includes an inclined guide member 84 which is inclined from the lower left toward the upper right, a first vertical part 86 contiguous with the inclined guide member 84 and extending vertically upward, and a first horizontal part 88 contiguous with the first vertical part 86 and extending horizontally to the left. The first regulating member 80 and the second regulating member 82 constitute a first guide member 90 which is configured to change the flow direction of the discharged hydrogen inside the first gas-liquid separation chamber 70 (specifically, to regulate the flow direction of the discharged hydrogen in a predetermined direction inside the first gas-liquid separation chamber 70).

The partition wall 66 abuts against a side surface portion on the front side of the drawing sheet of the first regulating member 80 and the second regulating member 82. In addition, an arcuate cutout 92 is formed at a lower left portion of the partition wall 66, and together therewith, a conduit 94 (see FIG. 2) bridges across from the second inlet port 62 to the arcuate cutout 92. Therefore, the second inlet port 62 is formed in a shape of being opened via the conduit 94 on a surface of the partition wall 66 in (facing toward) the second gas-liquid separation chamber 72.

In the vicinity of the opening of the conduit 94, or stated otherwise, in the vicinity of the opening of the second inlet port 62, a deflection member 96 is arranged in covering relation to the opening at a position spaced apart from the opening by a predetermined distance. The deflection member 96 serves to change the flow direction of the discharged hydrogen that flows in from the conduit 94 (the second inlet port 62), and opens in facing relation to a third regulating member 98 provided on the right side thereof.

The third regulating member 98 is formed integrally with a gripping member 104 that grips a right lower end of the partition wall 66 on an inclined surface 102 of a support base 100. The third regulating member 98 constitutes the second guide member 106 together with the dam plate 76, and changes the flow direction of the discharged hydrogen in the second gas-liquid separation chamber 72. More specifically, the flow direction of the discharged hydrogen in the second gas-liquid separation chamber 72 is regulated in a predetermined direction.

The third regulating member 98 is disposed at a position that overlaps substantially in a planar view with the second regulating member 82 that makes up the first guide member 90. More specifically, the third regulating member 98 is made up from a second vertical part 108 that overlaps substantially with the first vertical part 86, and a second horizontal part 110 connected to the second vertical part 108 and extending horizontally to the left, and which overlaps substantially with the first horizontal part 88. As can be understood from the description given above, the interior of the first gas-liquid separation chamber 70 and the second gas-liquid separation chamber 72 is of a crank-like shape formed by the first guide member 90 and the second guide member 106, respectively.

The support base 100 includes a guiding inclined portion 112 that serves as a guide path for guiding the water droplets D (see FIG. 4). Further, a predetermined step is formed between the inclined surface 102 and the guiding inclined portion 112, and a temporary liquid storage section 114 is formed by the step and the third regulating member 98 (second vertical part 108). The water droplets D which are guided by the guiding inclined portion 112 are temporarily stored in the temporary liquid storage section 114. A liquid transfer hole 116 (refer to FIGS. 3 and 4), through which the water stored in the temporary liquid storage section 114 is transferred to the side of the first gas-liquid separation chamber 70, is formed in the gripping member 104.

In the first gas-liquid separation chamber 70 and the second gas-liquid separation chamber 72, a bottom portion thereof is cut out so as to form a reservoir 118 having a predetermined volume. The reservoir 118 communicates with the first gas-liquid separation chamber 70 and the second gas-liquid separation chamber 72.

At the bottom of the reservoir 118, a drain port 120 is provided which serves as a liquid discharge member for discharging the water inside the reservoir 118. The drain valve 36 is connected to the drain port 120, and discharges the water in the reservoir 118 when the drain valve 36 is in an open state. On the other hand, the water is stored in the reservoir 118 when the drain valve 36 is in a closed state.

The gas-liquid separator 32 according to the present embodiment is basically configured in the manner described above. Next, functions and effects thereof will be described.

When the fuel cell stack 12 is operated, hydrogen as a fuel gas is supplied from the hydrogen tank 18 into the hydrogen supply flow passage 14. After having passed through either the first injector 24 of the first branch path 20 or the second injector 26 of the second branch path 22, the hydrogen further passes through the ejector 30 of the merged passage 28, and is supplied to the anode of the respective fuel cells that constitute the fuel cell stack 12.

On the other hand, compressed air serving as an oxygen containing gas is delivered via the air pump 44 into the air supply flow passage 40. The compressed air is humidified by the later-described exhaust compressed air, and then is supplied to the cathodes of the respective fuel cells that constitute the fuel cell stack 12.

By the reaction gases which are supplied as described above, electrode reactions are made to take place respectively at the anodes and the cathodes of the respective fuel cells. Consequently, electrical power is generated. Moreover, a cooling medium flow passage is formed in the fuel cell stack 12, and a cooling medium, which is supplied through a cooling medium supply flow passage, flows through the cooling medium flow passage.

The compressed air supplied to the cathodes and which is partially consumed is discharged as exhaust compressed air in the air discharge flow passage 42. The exhaust compressed air is a moist or humidified gas containing moisture generated by the electrode reaction at the cathodes. In a non-illustrated humidifier, this exhaust compressed air humidifies the oxygen containing gas that is newly supplied to the cathodes. Thereafter, the exhaust compressed air is set to a predetermined pressure and is discharged to the exterior of the fuel cell system 10.

On the other hand, the hydrogen supplied to the anodes and which is partially consumed is discharged as discharged hydrogen in the hydrogen discharge flow passage 16. During the process of flowing through the hydrogen discharge flow passage 16, the discharged hydrogen is supplied to the gas-liquid separator 32.

At this time, the discharged hydrogen is introduced separately into the casing 56 from the first inlet port 60 and the second inlet port 62 shown in FIG. 2. The discharged hydrogen that flows inwardly from the upper first inlet port 60 advances slightly in an inclined manner in a right downward direction along the inner wall of the internal chamber 50, and due to the presence of the partition wall 66, flows into the first gas-liquid separation chamber 70 that is formed on the rear side of the drawing sheet in FIG. 2. Moreover, the discharged hydrogen that attempts to advance into the second gas-liquid separation chamber 72 is blocked by the dam plate 76 provided on the end surface on the front side of the partition wall 66. Therefore, the discharged hydrogen that flows in from the first inlet port 60 is prevented from flowing into the second gas-liquid separation chamber 72.

The discharged hydrogen flowing into the first gas-liquid separation chamber 70 flows along the direction in which the first regulating member 80 extends. For this reason, the flow direction of the discharged hydrogen is changed from a right downward direction up to that point, and goes slightly leftward, rather than straight vertically downward.

Thereafter, the discharged hydrogen proceeds along the inclined guide member 84, and then the first vertical part 86 and the first horizontal part 88 of the second regulating member 82. Therefore, the flow direction of the discharged hydrogen changes sequentially from the lower left to the upper right, and from the upper right to a horizontal (leftward) direction. Furthermore, the discharged hydrogen rises by being guided by the end face of the first regulating member 80 that faces toward the second regulating member 82, and then the flow direction thereof is deflected toward the side of the collection chamber 74. As a result, the discharged hydrogen is led out from the first gas-liquid separation chamber 70 and arrives at the collection chamber 74. In FIG. 3, the above-described flow-through process is indicated by the arrows.

By such a flow-through process, the flow rate of the discharged hydrogen rapidly decreases. Furthermore, the first guide member 90 (the first regulating member 80, the second regulating member 82) is formed inside the first gas-liquid separation chamber 70, and the interior of the first gas-liquid separation chamber 70 is of a crank-like shape. Therefore, the discharged hydrogen remains within the first gas-liquid separation chamber 70 for a comparatively long time period. For the reasons described above, the discharged hydrogen (liquid-gas two-phase flow) supplied from the first inlet port 60 into the first gas-liquid separation chamber 70 is efficiently separated into a water portion, which is a liquid phase, and a first hydrogen gas flow (first gas flow), which is a vapor phase. The water portion is stored in the reservoir 118, and the first hydrogen gas flow flows into the collection chamber 74.

On the other hand, the discharged hydrogen that has flowed in a roundabout manner to the side of the lower second inlet port 62 passes via the conduit 94 disposed inside the first gas-liquid separation chamber 70, and is led out from the opening that faces toward the interior of the second gas-liquid separation chamber 72. Therefore, the discharged hydrogen that flows in from the second inlet port 62 is prevented from flowing into the first gas-liquid separation chamber 70.

In the vicinity of the opening, as described above, the deflection member 96 is provided which opens in a rightward direction. Therefore, the flow direction of the discharged hydrogen that is led out from the conduit 94 changes from the side of the closing member 54 to the side of the third regulating member 98 on the right. Thereafter, the discharged hydrogen proceeds along the second vertical part 108 and the second horizontal part 110 of the third regulating member 98. Therefore, the flow direction of the discharged hydrogen changes briefly from the lower left toward the upper right, and then from the upper right in a horizontal (leftward) direction. Furthermore, the discharged hydrogen rises while being guided by the inner wall of the internal chamber 50, and is further guided by the end surface of the dam plate 76 that faces toward the second gas-liquid separation chamber 72, whereupon the flow direction is deflected in a downward direction. As a result, the discharged hydrogen is led out from the second gas-liquid separation chamber 72 and arrives at the collection chamber 74. In FIG. 4, the above-described flow-through process is indicated by the arrows.

In a similar manner, in the second gas-liquid separation chamber 72 as well, by the aforementioned flow-through process, the flow rate of the discharged hydrogen rapidly decreases. Furthermore, the second guide member 106 (the third regulating member 98, the dam plate 76) is formed inside the second gas-liquid separation chamber 72, and therefore, the interior of the second gas-liquid separation chamber 72 is of a crank-like shape. Therefore, the discharged hydrogen remains within the second gas-liquid separation chamber 72 for a comparatively long time period. Accordingly, the discharged hydrogen (liquid-gas two-phase flow) supplied from the second inlet port 62 (conduit 94) into the second gas-liquid separation chamber 72 is efficiently separated into a water portion, which is a liquid phase, and a second hydrogen gas flow (second gas flow), which is a vapor phase. The water portion is stored in the reservoir 118 in the same manner as the water portion that was separated in the first gas-liquid separation chamber 70, and the second hydrogen gas flow flows into the collection chamber 74.

In the foregoing manner, according to the present embodiment, the discharged hydrogen gas that has flowed into the casing 56 from the first inlet port 60, and the discharged hydrogen that has flowed into the casing 56 from the second inlet port 62 are introduced separately into the first gas-liquid separation chamber 70 and the second gas-liquid separation chamber 72, together with gas-liquid separation being carried out respectively therein. Accordingly, even in the case that the fluid pressures and the flow rates of both of the discharged hydrogen sources differ from each other, the respective fluxes of the discharged hydrogen do not interfere with each other inside the first gas-liquid separation chamber 70 and the second gas-liquid separation chamber 72. Therefore, the discharged hydrogen is sufficiently separated into the water portion and the second hydrogen gas flow. Stated otherwise, the gas-liquid separation efficiency increases.

Further, the second regulating member 82 and the third regulating member 98 are formed mutually in substantially the same shape. Furthermore, the first gas-liquid separation chamber 70 and the second gas-liquid separation chamber 72 communicate with each other through the breathing holes 78a, 78b that are formed in the partition wall 66. Therefore, the flow rate and the fluid pressure of the discharged hydrogen inside the first gas-liquid separation chamber 70, and the flow rate and the fluid pressure of the discharged hydrogen inside the second gas-liquid separation chamber 72 become substantially equivalent. As a result, the gas-liquid separation efficiencies in the first gas-liquid separation chamber 70 and the second gas-liquid separation chamber 72 also become substantially equivalent. Accordingly, for example, there is no need to increase the withstand pressure of one of the gas-liquid separation chambers so as to be greater than that of the other gas-liquid separation chamber.

Provisionally, in the event that the gas-liquid separation efficiency in the first gas-liquid separation chamber 70 is greater than that in the second gas-liquid separation chamber 72, and a greater amount of water is separated in the first gas-liquid separation chamber 70, the water portion is transferred into the second gas-liquid separation chamber 72 via the breathing holes 78a, 78b. Conversely, at a time that the gas-liquid separation efficiency in the second gas-liquid separation chamber 72 is greater than that in the first gas-liquid separation chamber 70, the water portion is transferred into the first gas-liquid separation chamber 70 via the breathing holes 78a, 78b. Therefore, storage of an excessive amount of the liquid phase in the first gas-liquid separation chamber 70 or the second gas-liquid separation chamber 72, and due to such an occurrence, difficulty in carrying out gas-liquid separation in the first gas-liquid separation chamber 70 or the second gas-liquid separation chamber 72 can be avoided.

Accordingly, there is no need to increase the volume of the first gas-liquid separation chamber 70 or the second gas-liquid separation chamber 72 in order to enable a large amount of the liquid phase to be stored therein. Therefore, it is possible to reduce the size of the gas-liquid separator 32. Consequently, it is possible to narrow the installation space for the gas-liquid separator 32, or in other words, to achieve a space savings. As a result, the degree of layout freedom for the fuel cell system 10 in a fuel cell vehicle is improved.

The first hydrogen gas flow that is led out from the first gas-liquid separation chamber 70, and the second hydrogen gas flow that is led out from the second gas-liquid separation chamber 72 are collected together in the collection chamber 74 and become a merged flow. More specifically, the flow directions of the first hydrogen gas flow and the second hydrogen gas flow are substantially parallel with each other. Such a merged flow flows into the circulation flow passage 34 (see FIG. 1) via the outlet port 64. Thereafter, the merged flow is drawn in from the circulation flow passage 34 into the ejector 30, and is resupplied together with newly supplied hydrogen to the anodes.

The merged flow (the first hydrogen gas flow and the second hydrogen gas flow) still contains a small amount of moisture. Therefore, accompanying the merged flow coming into contact with the inner wall of the collection chamber 74, the moisture is liquefied and becomes water droplets D (liquid phase) which adhere to the inner wall of the collection chamber 74.

The water droplets D flow downward under the action of gravity, and more specifically, flow downward toward the bottom of the collection chamber 74. In this instance, the guiding inclined portion 112, which is disposed on the support base 100, is positioned at the bottom of the collection chamber 74. The water droplets D are guided by the guiding inclined portion 112, and are temporarily stored in the temporary liquid storage section 114 as a result of being blocked by the second vertical part 108 of the third regulating member 98. Since the temporary liquid storage section 114 is located at a position significantly distanced from the outlet port 64, the water portion that is stored in the temporary liquid storage section 114 is prevented from being drawn into the ejector 30 together with the merged flow.

The liquid transfer hole 116 is formed in the gripping member 104 of the support base 100. Accordingly, when a predetermined amount of water has been stored in the stepped portion, the water overflows from the liquid transfer hole 116. Consequently, the water portion is transferred into the reservoir 118.

When a predetermined amount or more of the water portion is stored in the reservoir 118, the ECU 46 issues a command signal in order to open the drain valve 36 (see FIG. 1). By the drain valve 36 which has received the command signal being placed in an open state, the water portion is discharged to the exterior of the casing 56 through the drain port 120 and the drain valve 36.

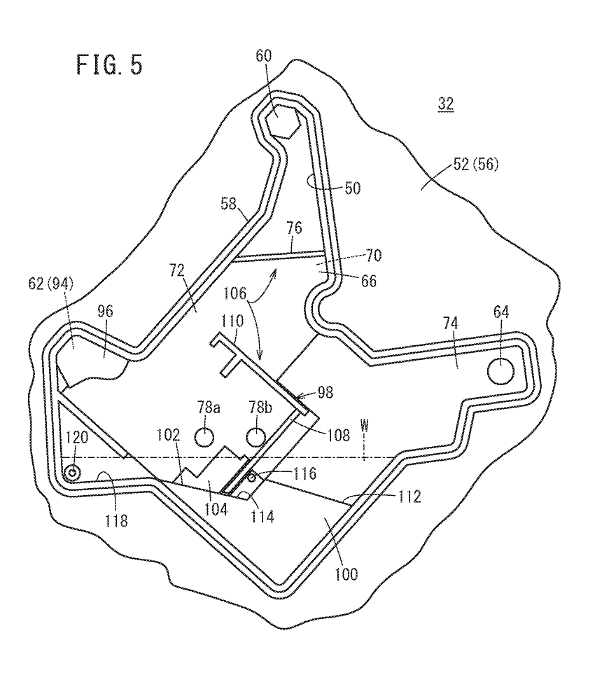

In the case that the fuel cell system 10 is installed in a fuel cell vehicle (not shown) such as a fuel cell electric vehicle or the like, the vehicle body may become inclined accompanying the user performing a steering operation or the like. In this case, as shown in FIG. 5, the gas-liquid separator 32 is also placed in an inclined posture. Along therewith, the water portion in the reservoir 118 moves into the first gas-liquid separation chamber 70 and the second gas-liquid separation chamber 72.

The breathing holes 78a, 78b are arranged at positions so as to be higher than the liquid surface level at a time that the gas-liquid separator 32 in which the reservoir 118 thereof has been filled with the liquid is in an inclined posture, and the entire amount of the liquid has been moved into the first gas-liquid separation chamber 70 and the second gas-liquid separation chamber 72. Stated otherwise, the breathing holes 78a, 78b are provided above the liquid surface level of the water portion which has been moved from the reservoir 118 into the first gas-liquid separation chamber 70 and the second gas-liquid separation chamber 72 when the gas-liquid separator 32 has been placed in an inclined posture.

Accordingly, in this case, the breathing holes 78a, 78b are not blocked by the stored water W which is indicated by the imaginary line in FIG. 5. Therefore, even if the gas-liquid separator 32 is placed in an inclined condition, communication between the first gas-liquid separation chamber 70 and the second gas-liquid separation chamber 72 is maintained through the breathing holes 78a, 78b. Thus, in the same manner as mentioned previously, the gas-liquid separation efficiency can be made substantially equal.

According to the present embodiment, the first inlet port 60, the second inlet port 62, and the outlet port 64 are formed on the same end surface of the main body member 52. Therefore, it is easy for processing to be carried out from the material and until the main body member 52 is obtained from the material.

The present invention is not particularly limited to the embodiment described above, and various modifications are possible without departing from the essence and gist of the present invention.

For example, the fuel cell system 10 including the gas-liquid separator 32 is not particularly limited to being a vehicle-mounted type of system, and the fuel cell system 10 may be a stationary type of system.

Further, the gas-liquid separator 32 is not particularly limited to being constituted in the form of a fuel cell system 10, and may be of any type of system insofar as it is used for introducing a gas-liquid two-phase flow into the interior of the casing 56 from a plurality of inlet ports. The gas-liquid two-phase flow may also be of another type apart from hydrogen in which moisture is contained.

What is claimed is:

1. A gas-liquid separator configured to separate a gas-liquid two-phase flow into a gas phase and a liquid phase inside a casing, wherein the casing comprises:
a first inlet port and a second inlet port to which the gas-liquid two-phase flow is separately supplied;
a first gas-liquid separation chamber configured to separate the gas-liquid two-phase flow introduced from the first inlet port into a liquid phase and a first gas flow;
a second gas-liquid separation chamber separated from the first gas-liquid separation chamber by a partition wall, and configured to separate the gas-liquid two-phase flow introduced from the second inlet port into a liquid phase and a second gas flow;
a collection chamber configured to collect the first gas flow obtained in the first gas-liquid separation chamber and the second gas flow obtained in the second gas-liquid separation chamber, and thereby produce a merged flow; and
an outlet port through which the merged flow is discharged.

2. The gas-liquid separator according to claim 1, wherein the first inlet port is provided above the second inlet port, and the gas-liquid two-phase flow introduced from the first inlet port is guided downward, and thereafter, is raised and directed toward the collection chamber.

3. The gas-liquid separator according to claim 2, wherein the gas-liquid two-phase flow introduced from the second inlet port is raised, and thereafter, is made to descend and is directed toward the collection chamber.

4. The gas-liquid separator according to claim 1, wherein a breathing hole is formed in the partition wall and configured to enable the first gas-liquid separation chamber and the second gas-liquid separation chamber to communicate with each other.

5. The gas-liquid separator according to claim 4, further comprising a reservoir configured to communicate with both the first gas-liquid separation chamber and the second gas-liquid separation chamber, and to store the liquid phase separated from the gas-liquid two-phase flow in the first gas-liquid separation chamber and the second gas-liquid separation chamber,
wherein the breathing hole is formed at a position above a liquid surface level of the liquid phase, which has moved from the reservoir into the first gas-liquid separation chamber and the second gas-liquid separation chamber when the gas-liquid separator is placed in an inclined posture.

6. The gas-liquid separator according to claim 1, further comprising a guide path configured to guide the liquid phase that is adhered to an inner wall of the collection chamber toward a liquid discharge member.

7. The gas-liquid separator according to claim 1, wherein the first inlet port, the second inlet port, and the outlet port are formed on a same end surface of the casing, and the second inlet port opens on a surface of the partition wall in the second gas-liquid separation chamber.

8. The gas-liquid separator according to claim 1, wherein a first guide member and a second guide member, which are configured to guide the first gas flow and the second gas flow in a manner so that the flow directions thereof change, are disposed respectively in the first gas-liquid separation chamber and the second gas-liquid separation chamber.

9. The gas-liquid separator according to claim 1, wherein the gas-liquid separator is attached to a fuel cell and constitutes a fuel cell system, wherein a fuel exhaust gas discharged from an anode of the fuel cell is supplied as the gas-liquid two-phase flow.
